(19) United States
(12) Patent Application Publication
(10) Pub. No.: US 2020/0223558 A1
(43) Pub. Date: Jul. 16, 2020

(54) MOTION SENSOR ASSEMBLY AND UNMANNED AERIAL VEHICLE

(71) Applicant: SZ DJI TECHNOLOGY CO., LTD., Shenzhen (CN)

(72) Inventors: Jiangang FENG, Shenzhen (CN); Yongze QI, Shenzhen (CN); Tongyao HUANG, Shenzhen (CN)

(21) Appl. No.: 16/834,423

(22) Filed: Mar. 30, 2020

Related U.S. Application Data
(63) Continuation of application No. PCT/CN2017/110655, filed on Nov. 13, 2017.

(51) Int. Cl. B64D 45/06; B64D 47/00; F16F 15/04; G01P 1/02

(52) U.S. Cl. CPC B64D 45/06; G01P 1/023; F16F 15/04; B64D 47/00

(57) ABSTRACT

The present disclosure provides a motion sensor assembly applied to an unmanned vehicle. The motion sensor assembly includes a mounting bracket, a sensor assembly body, and a shock absorption mechanism disposed between the mounting bracket and the sensor assembly body. The sensor assembly body includes a protective casing and a sensor module disposed in the protective casing. The shock absorption mechanism including a plurality of elastic members, which are disposed between the mounting bracket and the protective casing for absorbing the shock of the sensor module in the protective casing.

### CROSS-REFERENCE TO RELATED APPLICATION

This application is a continuation of International Application No. PCT/CN2017/110655, filed Nov. 13, 2017, the entire content of which is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure relates to the field of motion sensor shock absorption technology and, more particularly, to a motion sensor assembly having a multi-sided buffering and shock absorption capacity, and an unmanned aerial vehicle thereof.

### BACKGROUND

Motion sensors are a commonly used detection instrument and have applications in many industries. With the continuous development of technology, there are more and more types of motion sensors. The commonly used motion sensors mainly include acceleration sensors, gyroscopes, geomagnetic sensors, and inertial measurement units (IMUs), etc. The IMU internally contains an accelerometer and a gyro, where the accelerometer is used to detect the proper acceleration of an object, and the gyro is used to detect the angular information of the object. In general, IMU is installed at the center of gravity of an object. With its capacity to measure the three-axis attitude angle (or angular rate) and acceleration of an object, IMU is often used as a core component of navigation and guidance, and is widely used in vehicles, ships, robots, unmanned vehicles, etc., that require motion control.

In unmanned vehicles, motion sensors are used to feed back the attitude of an unmanned vehicle. However, because the high-speed movement of an unmanned vehicle causes a motion sensor to be in a vibrating environment, excessive vibrations and/or high vibration levels may cause the accelerometer and gyro of a motion sensor to drift a lot. This makes it quite difficult to ensure high measurement accuracy, and in serious cases even causes damage to the components of a motion sensor.

### SUMMARY

In accordance with the present disclosure, there is provided a motion sensor assembly applied to an unmanned vehicle. The motion sensor assembly includes a mounting bracket, a sensor assembly body, and a shock absorption mechanism disposed between the mounting bracket and the sensor assembly body. The sensor assembly body includes a protective casing and a sensor module disposed in the protective casing. The shock absorption mechanism including a plurality of elastic members, which are disposed between the mounting bracket and the protective casing for absorbing the shock of the sensor module in the protective casing.

### BRIEF DESCRIPTION OF THE DRAWINGS

FIG. 1 is a schematic structural diagram of a motion sensor assembly according to an embodiment of the present disclosure;

FIG. 2 is a schematic structural diagram of a split motion sensor assembly according to an embodiment of the present disclosure;

FIG. 3 is a schematic structural diagram of a shock absorption ball according to an embodiment of the present disclosure;

FIG. 4 is a schematic structural diagram of a split sensor assembly body according to an embodiment of the present disclosure;

FIG. 5 is a schematic structural diagram of a split sensor assembly body from another angle of view according to an embodiment of the present disclosure;

FIG. 6 is a schematic structural diagram of a motion sensor mounted on a fuselage according to an embodiment of the present disclosure;

FIG. 7 is a schematic diagram of a split structure of a motion sensor mounted on a fuselage according to an embodiment of the present disclosure; and

FIG. 8 is a schematic cross-sectional diagram of an unmanned aerial vehicle according to an embodiment of the present disclosure.

### DETAILED DESCRIPTION OF THE EMBODIMENTS

Technical solutions of the present disclosure will be made in detail hereinafter with reference to the accompanying drawings. It will be appreciated that the described embodiments are merely some but not all of the embodiments of the present disclosure. Other embodiments conceived by those having ordinary skills in the art on the basis of the described embodiments without inventive efforts should fall within the protection scope of the present disclosure.

Exemplary embodiments will be described in detail herein, examples of which are illustrated in the accompanying drawings. Unless otherwise defined, all the technical and scientific terms used herein have the same or similar meanings as generally understood by one of ordinary skill in the art. The embodiments described in the following exemplary embodiments do not represent all embodiments consistent with the present disclosure. Instead, they are merely examples of devices and methods consistent with aspects of the present disclosure as detailed in the appended claims.

The terms used in the present disclosure are for the purpose of describing embodiments, and not intended to limit the present disclosure. The singular forms “a”, “the” and “this” also include the corresponding plural forms unless the context clearly defines other meanings. It should be also understood that the term “and/or” as used herein refers to and encompasses any and all possible combinations of one or more of the related items listed.

The structure of a motion sensor assembly of the present disclosure and an unmanned aerial vehicle thereof will be described in detail hereinafter with reference to the accompanying drawings. Unless otherwise noted as having an obvious conflict, the embodiments or features included in various embodiments may be combined.

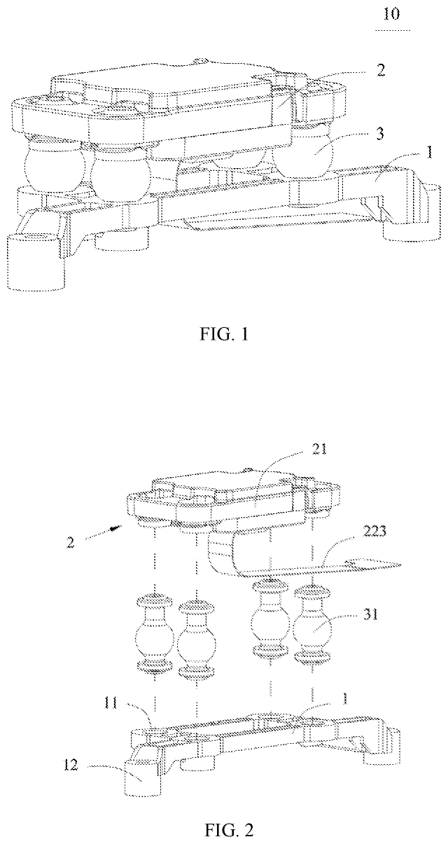

As shown in FIGS. 1, 2 and 4, the embodiments of the present disclosure provide a motion sensor assembly 10 applied to an unmanned vehicle. The unmanned vehicle may be an unmanned aerial vehicle, a self-driving vehicle, or an unmanned ship, etc. The disclosed embodiments take an unmanned aerial vehicle (UAV) as an example of the unmanned vehicle. The motion sensor assembly 10 includes a mounting bracket 1, a sensor assembly body 2, and a shock absorption mechanism 3 connecting and disposed between the mounting bracket 1 and the sensor assembly body 2. The shock absorption mechanism 3 is used to absorb the shock of the sensor assembly body 2, to protect a motion sensor 222 and ensure the measurement accuracy of the motion sensor 222. In the disclosed embodiments, the mounting bracket 1 is used for connection with the fuselage of a UAV. It may be understood that the mounting bracket 1 may also be part of the fuselage of a UAV.

The sensor assembly body 2 includes a protective casing 21 and a sensor module 22 disposed inside the protective casing 21. The protective casing 21 includes a receiving chamber 2110 for holding the sensor module 22. The protective casing 21 includes an elastic structure that may be used to absorb the impact force around the motion sensor assembly 10. This may prevent the motion sensor 222 from hitting objects and being jammed or stuck without reading due to the limited space surrounding the motion sensor when the UAV experiences a large external force (e.g., due to a big dive or an abrupt motion, etc.) under normal flight conditions.

The protective casing 21 includes an upper casing 211 and a lower casing 212, and the elastic structure is a part of the upper casing 211. The shock absorption mechanism 3 is connected with the protective casing 21. The sensor module 22 is disposed between the upper casing 211 and the lower casing 212, and the upper casing 211 and the lower casing 212 are assembled to enclose the motion sensor 222 inside the protective casing 21. The receiving chamber 2110 is disposed in the upper casing 211. The sensor module 22 may be fixed in the receiving chamber 2110 by double-sided adhesive bonding, glue fixing, screwing, or by adding an adapter. It may be understood that the receiving chamber 2110 may also be disposed in the lower casing 212 or partially disposed in the upper casing 211 and partially disposed in the lower casing 212.

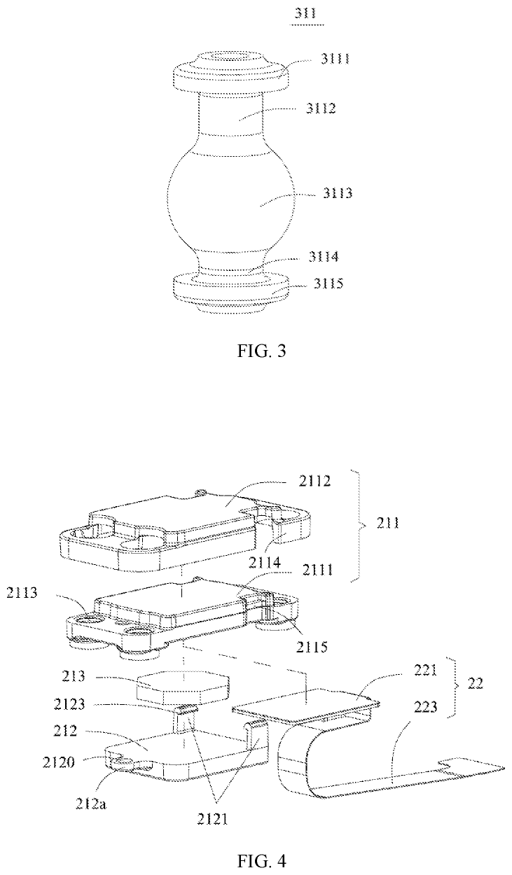

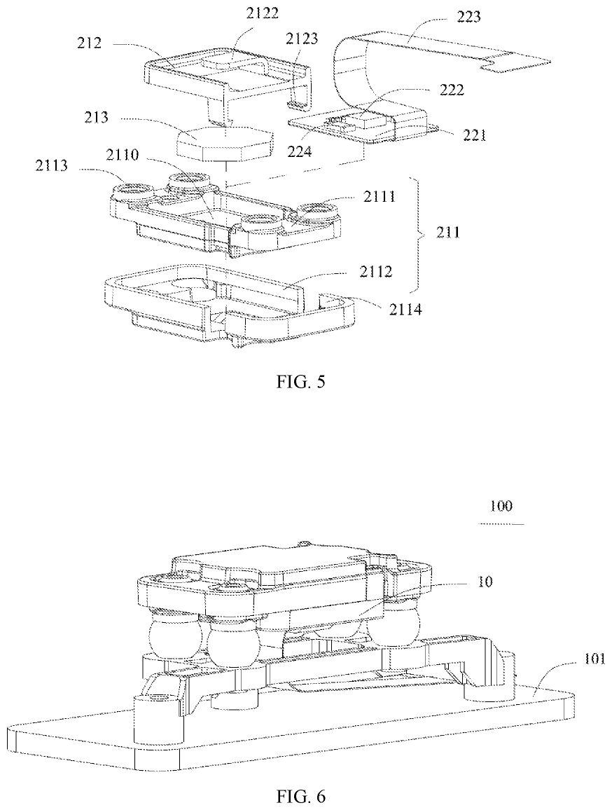

As shown in FIGS. 4 and 5, in some embodiments, the upper casing 211 includes an inner casing 2111 and an elastic casing 2112 that wraps around the inner casing 2111. The elastic casing 2112 is an elastic structure of the protective casing 21. The receiving chamber 2110 is disposed in the inner casing 2111. The elastic casing 2112 is used for alleviating the impact from the surrounding of the sensor assembly body 2. The elastic casing 2112 is made of an elastic material. In an example embodiment, a silicone rubber may be coated with a low hardness silicone rubber to cover the inner casing 2111 to form the protective casing 21 of the present disclosure. The inner casing 2111 may be a plastic casing or a low-density metal casing. In the disclosed embodiments, the inner casing 2111 is made of a plastic casing to reduce the weight of the motion sensor assembly 10, which facilitates the weight reduction of the UAVs.

In the manufacturing process, since a silicone itself is an inert material, the silicone must be modified to better connect with the plastic casing. Specifically, a silicone modification treatment agent is pre-coated on the plastic casing. Then, the silicone is heated and a spray coating is formed on the plastic casing. Apparently, the elastic casing 2112 of the present disclosure is not limited to the above material and manufacturing process. Other structures that contain elastic and low-density materials, for example, foam, thermoplastic elastomer, etc., may be applied to the protective casing 21 of the present disclosure.

Further, the circumferential side of the protective casing 21 is provided with an elastic arm 2114. That is, the circumferential side of the elastic casing 2112 may be provided with an elastic arm structure or an elastic arc structure. For instance, an elastic arm 2114 is provided at least at one end of the elastic casing 2112 in the flight direction. In this way, the impact force on the sensor module 22 may be further alleviated by the material and structural features of the protective casing 21 of the present disclosure.

In some embodiments, the upper casing 211 includes an inner casing 2111 and an elastic frame (not shown) disposed at a circumferential side surface of the inner casing 2111. The elastic frame is an elastic structure of the protective casing 21. The receiving chamber 2110 is disposed in the inner casing 2111. The elastic frame is used to alleviate the impact of the circumferential side of the sensor assembly body 2. The specific way of assembly and the specific shape of the elastic frame may be set according to design requirements.

Referring again to FIGS. 4 and 5, the protective casing 21 may further include two latching arms 2121 oppositely disposed at the lower casing 212. In the disclosed embodiments, the lower casing 212 has a square structure, and the two latching arms 2121 are oppositely disposed and are respectively located at two sides of the lower casing 212. The two latching arms 2121 are cooperatively clamped to the upper casing 211, to allow the upper casing 211 to be snap-fitted on the lower casing 212, thereby realizing a fixed and packed sensor module 22. In the disclosed embodiments, a latching arm 2121 is a resilient structure, and the inner side of the free end of the latching arm 2121 is provided with a hook 2123. The upper casing 211 is provided with a slot 2115 for engaging with the hook 2123. When the upper casing 211 is cooperatively assembled with the lower casing 212, the latching arm 2121 extends to the upper casing 211, and the hook 2123 is snap-fitted in the slot 2115, to allow the upper casing 211 and the lower casing 212 to be assembled. When dissembling the upper casing 211 from the lower casing 212, an external force may act on a latching arm 2121 to resiliently deform the latching arm 2121 to disengage the hook 2123 from the slot 2115, thereby allowing the upper casing 211 and the lower casing to be separated. The structure organized this way is simple to assemble and easy to disassemble. It is to be understood that in some embodiments, the lower casing 212 may have other shapes. For example, the lower casing 212 may also be configured to have the same shape as the upper casing 211.

Further, a connection plate 212a may be perpendicularly extended on one side of the lower casing 212. The lower casing 212 is coupled to the upper casing 211 through the connection plate 212a, so that the upper casing 211 and the lower casing 212 may be further fixed. Here, the connection plate 212a contains a threaded hole 2120. Through the engagement of the screw and the threaded hole 2120, the connection plate 212a fixes the lower casing 212 to the upper casing 211. Through the combined use of both the threaded hole 2120 and the hatching arms 2121 to fix the lower casing 212 on the upper casing 211, the screw engagement between the upper casing and the lower casing may be reduced, thereby simplifying the assembly process.

The sensor module 22 of the present disclosure includes a control circuit board 221, a motion sensor 222 disposed at the control circuit board 221, a thermal resistor 224 disposed at the control circuit board 221, and a connection line 223 electrically connected to a mounting carrier (i.e., the fuselage of a UAV in the present disclosure). The thermal resistor 224 is disposed on one side of the motion sensor 222. The motion sensor 222 and the thermal resistor 224 are disposed at the control circuit board 221 on a side opposite to the lower casing 212, to allow them to be in the space between the upper casing 211 and the lower casing 212 and thus be protected. The motion sensor 222 selects an IMU, and acquires the proper acceleration and angular information of the UAV through the accelerometer and gyro of the IMU. One end of the connection line 223 is connected to the control circuit board 221, and the other end is connected to the fuselage of a UAV, thereby implementing a communication connection between the fuselage and the sensor module 22. Optionally, an FPC (flexible printed circuit) is selected as the connection line 223 for connection, so that the space occupied by the connection line 223 may be reduced.

The sensor assembly body 2 of the present disclosure further includes a thermally conductive structural layer 213 disposed between the sensor module 22 and the lower casing 212. The upper casing 211 and the lower casing 212 cooperate to encapsulate the motion sensor 222, the thermal resistor 224, the control circuit board 221, and the thermally conductive structure layer 213. In the disclosed embodiments, the thermally conductive structural layer 213 is made of thermally conductive silicone for wrapping or covering the motion sensor 222 and the thermal resistor 224, to transfer the heat generated by the thermal resistor 224 to the motion sensor 222, to maintain heat for the motion sensor 222. This allows the motion sensor 222 to operate at a relatively constant temperature, to improve the stability of the operation of the motion sensor 222. In some embodiments, the thermally conductive structural layer 213 is not limited to thermally conductive silicone. Other thermally insulating materials may also be used for the thermally conductive structural layer 213.

The protective casing 21 further includes a locking member 2122 disposed at the lower casing 212. In one example, the locking member 2122 is located on a side of the lower casing 212 opposite to the sensor module 22, and is used to lead the connection line out of the lower casing 212 from the bottom of the lower casing (as shown in FIG. 4). That is, the connection line 223 is led out from the side where the lower casing 212 has the locking member 2122. Specifically, the locking member 2122 is used to restrain the connection line 223 under the lower casing 212, so that the stress generated, when the motion sensor 222 and FPC move, may be reduced. It should be noted that the locking member 2122 can be disposed at the lower casing at different positions, but is not limited to the position described in the above example. For instance, under certain circumstances, the locking member 2122 may be located on a same side of the lower casing 212 as the sensor module 22, or on a circumferential side of the lower casing 22, etc.

In the disclosed embodiments, the thermally conductive structure layer 213 is attached to the motion sensor 222 and the thermal resistor 224. After the connection line 223 is led away from the control circuit board 221, the connection line 223 is attached to the thermally conductive structure layer 213 on a side away from the motion sensor 222. Next, the connection line 223 is bent along the end of the lower casing 212 and then led to the lower surface of the lower casing 212 and restrained by the locking member 2122, and finally aligns along the plane of the lower casing 212.

As shown in FIGS. 1-3, the shock absorption mechanism 3 of the present disclosure includes a plurality of elastic members 31, where each elastic member 31 is disposed between the mounting bracket 1 and the protective casing 21, to implement shock absorption for the motion sensor assembly 10. In the disclosed embodiments, the mounting bracket 1 is used for attaching to the fuselage of a UAV to fix the motion sensor assembly 10 to the fuselage of the UAV. The mounting bracket 1 is provided with a connecting portion 12 for mating connection to the mounting carrier. Specifically, the connecting portion 12 is a connecting hole, and the mounting bracket 1 may be fixed to the fuselage by screwing through the connecting hole. Apparently, the mounting bracket 1 of the present disclosure is not limited to the manner of the screw engagement, and may be fixed to the fuselage of the UAV by means of snap-fit, welding, bonding, or the like.

In addition, in some embodiments of the present disclosure, the motion sensor assembly 10 does not include a mounting bracket 1, but rather directly abuts against the fuselage of the UAV through the elastic members 31. That is, one end of an elastic member 31 abuts against the protective casing 21 and the other end abuts against the fuselage of the UAV. In this way, the six-sided buffering of the motion sensor assembly 10 may also be achieved.

Here, the number of shock absorption mechanism 3 may be a plurality, and the adjacent two shock absorption mechanisms 3 have respective preset spacings. The spacings for the plurality of shock absorption mechanisms 3 may be preset according to specific design requirements.

In some embodiments, the shock absorption mechanisms 3 may be evenly distributed between the mounting bracket 1 and the protective casing 21 to achieve a better shock absorption performance. One end of an elastic member 31 abuts against the mounting bracket 1, and the other end of the elastic member 31 abuts against the protective casing 21. When the UAV is impacted, through deformation, the elastic member 31 buffers the shock transmitted to the sensor assembly body 2, thereby implementing the shock absorption of the sensor assembly body 2, that is, achieving the shock absorption of the motion sensor inside the protective casing 21. In the disclosed embodiments, since the size of the motion sensor assembly 10 is small, a plurality of elastic members 31 may be disposed at the edges of the protective casing 21. This kind of arrangement may enhance the shock absorption capacity of the motion sensor assembly 10 as a whole. Further, the plurality of elastic members 31 may be diagonally arranged on the protective casing 21.

The elastic member 31 is composed of an elastic material having a certain shock absorption capacity, and the shock absorption coefficients of the plurality of elastic members 31 are the same, so that the overall shock absorption performance of the sensor assembly body 2 may be balanced. The materials of the plurality of elastic members 31 may be the same or different. Those skilled in the art may configure the elastic members 31 according to specific design requirements.

In a case where the shock absorption mechanisms 3 are disposed at different positions between the mounting bracket 1 and the protective casing 21, the shock absorption coefficient of an elastic member 31 near the center of gravity of the motion sensor assembly 10 is greater than the shock absorption coefficient of an elastic member 31 away from the center of gravity of the motion sensor assembly 10. This configuration ensures that the overall shock absorption performance of the sensor assembly body 2 is balanced, which helps improve the accuracy of the motion sensor measurement.

The sensor assembly body 2 may push an elastic member 31 or pull an elastic member 31, in a direction opposite to the mounting bracket 1, to deform an elastic member 31, so as to absorb shock for the sensor assembly body 2. Here, the elastic member 31 includes at least one of the following: a shock absorption ball 311, a spring, a spring board, or a shock absorbing cushion. Apparently, the elastic member 31 is not limited to the foregoing examples, and any elastic member 31 that can exert a shock absorption effect is contemplated for the elastic member 31 in the present disclosure.

As shown in FIGS. 2 and 3, in the disclosed embodiments, an elastic member 31 is a shock absorption ball. Specifically, the elastic member 31 includes an upper end portion 3111, a shock absorption main body 3113, and an upper neck portion 3112 connecting the upper end portion 3111 and the shock absorption main body 3113. The upper end portion 3111 and the upper neck portion 3112 are used for connecting with the protective casing 21. The shock absorption main body 3113 abuts against the protective casing 21, to absorb shock for the protective casing 21, thereby absorbing shock for the motion sensor 222.

The upper neck portion 3112 may be in the shape of a column. The protective casing 21 is provided with a first mounting hole 2113 that holds the upper neck portion 3112. In the disclosed embodiments, the first mounting hole 2113 is formed on the upper casing 211 of the protective casing 21. In some embodiments, the first mounting hole 2113 may also be formed on the lower casing 212, or correspondingly formed on the upper casing 211 and the lower casing 212. The upper neck portion 3112 may pass through the first mounting hole 2113 of the protective casing 21 to achieve engagement of the shock absorption ball 311 with the sensor assembly body 2. In the disclosed embodiments, the axial height of the upper neck portion 3112 is smaller than the depth of the first mounting hole 2113, so that the shock absorption main body 3113 abuts against the protective casing 21, and thus the upper end portion 3111 and the shock absorption main body 3113 are cooperatively snap-fitted in the protective casing 21. This can effectively alleviate the shaking between the shock absorption mechanism 3 and the sensor assembly body 2, which helps reduce vibration.

The shock absorption ball 311 further includes a lower end portion 3115, and a lower neck portion 3114 connecting the lower end portion 3115 and the shock absorption main body 3113. The lower neck portion 3114 and the lower end portion 3115 are used for connecting with the mounting bracket 1. The shock absorption main body 3113 abuts against the mounting bracket 1. Correspondingly, the mounting bracket 1 is provided with a second mounting hole 11 that holds the lower neck portion 3114. The lower neck portion 3114 may pass through the second mounting hole 11 of the mounting bracket 1 to achieve engagement of the shock absorption ball 311 with the mounting bracket 1. The axial height of the lower neck portion 3114 is smaller than the depth of the second mounting hole 11 so that the shock absorption main body 3113 abuts against the mounting bracket 1, and thus the lower end portion 3115 and the shock absorption main body 3113 are cooperatively snap-fitted on the mounting bracket 1. Apparently, the second mounting hole 11 may also be disposed at the fuselage of the UAV to allow the shock absorption main body 3113 abut against the fuselage of the UAV. This can effectively alleviate the shaking between the shock absorption mechanism 3 and the mounting bracket 1, which helps reduce vibration.

The shock absorption main body 3113 may have a spherical shape to facilitate the shock absorption main body 3113 to abut against the mounting bracket 1 and the sensor assembly body 2, so that the shock transmitted to the sensor assembly body 2 may be absorbed through the deformation of the shock absorption main body 3113. Therefore, the shock absorption of the sensor assembly body 2 is realized, that is, the shock absorption of the motion sensor within the sensor assembly body 2 is achieved. Structures arranged in this way may satisfy the six-sided buffering requirement, i.e., the six-degree-of-freedom shock absorption requirement, of the motion sensor assembly 10 of the present disclosure.

In some embodiments, the end of the shock absorption main body 3113 towards the sensor assembly body 2 may be hemispherical, so that the shock absorption main body 3113 abuts against the protective casing 21. Accordingly, through the deformation of shock absorption main body 3113, shock transmitted to the sensor assembly body 2 may be absorbed. This then realizes the shock absorption of the sensor assembly body 2, that is, realizes the shock absorption of the motion sensor within the sensor assembly body 2. Structures arranged in this way may also satisfy the six-sided buffering requirement of the motion sensor assembly 10 of the present disclosure.

The shock absorption main body 3113 may be configured with a hollow structure, for example, a hollow elliptical shape, a hollow cylindrical shape, or the like. The shapes of a plurality of shock absorption main bodies 3113 may be the same or different. In the disclosed embodiments, by configuring the shock absorption main body 3113 as a hollow structure, on one hand, the deformability of the shock absorption main body 3113 may be increased, and thus the shock absorption capacity may be increased. On the other hand, the weight of the shock absorption mechanism 3 may be reduced, which facilitates the weight reduction of UAVs.

In some embodiments, the shock absorption ball 311 may be an all-in-one structure. That is, the upper end portion 3111, the upper neck portion 3112, the shock absorption main body 3113, the lower neck portion 3114, and the lower end portion 3115 are all integrally into one structure. In some embodiments, the upper end portion 3111 of the shock absorption ball 311 is detachably attached to the upper neck portion 3112, and/or the upper neck portion 3112 is detachably attached to the shock absorption main body 3113, and/or the shock absorption main body 3113 is detachably attached to the lower neck portion 3114, and/or the lower neck portion 3114 is detachably attached to the lower end portion 3115. Specifically, each portion may be assembled and fixed by an interference fit connection, a threaded engagement connection, or the like.

The present disclosure provides a motion sensor assembly with a better protection performance. The combined elasticity of the protective casing and the shock absorption mechanism allows the UAVs to achieve a six-sided buffering, which absorbs a large amount of shock effectively. This solves the problem that the motion sensor in the motion sensor assembly is prone to jamming or even damage when a UAV dives and move abruptly.

Referring to FIGS. 6-8, in another aspect, the embodiments of the present disclosure provide a UAV 100. The UAV 100 includes a fuselage 101, a flight controller 103 disposed at the fuselage 101, a control circuit board 102 carrying the flight controller 103, and a motion sensor assembly 10 as described in the various embodiments described above. The motion sensor assembly 10 includes a mounting bracket 1, a sensor assembly body 2, and a shock absorption mechanism 3 connecting and disposed between the mounting bracket 1 and the sensor assembly body 2. The motion sensor assembly 10 may be mounted on the control circuit board 102 and electrically coupled to the control circuit board 102 via the connection line 223. The shock absorption mechanism 3 includes a plurality of elastic members 31, where each elastic member 31 is disposed between the mounting bracket 1 and the sensor assembly body 2 for shock absorption of the sensor module 22 in the sensor assembly body 2.

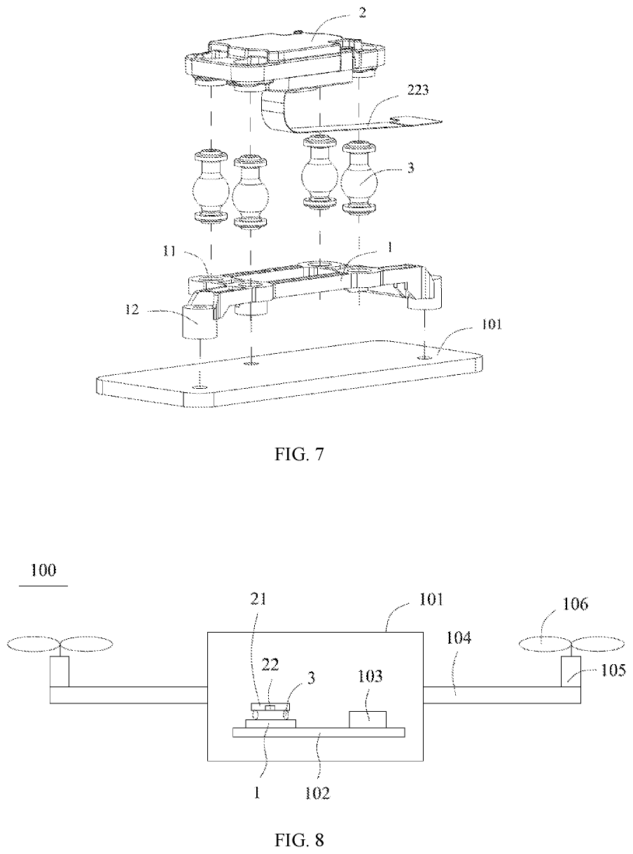

It should be noted that while the flight controller 103, the control circuit board 102, and different units of the motion sensor assembly 10 are illustrated as being disposed inside the fuselage 101 in FIG. 8, in some embodiments, one or more of these components or units may be disposed outside the fuselage. For instance, the flight controller 103 may be disposed outside the fuselage 101 under certain circumstances. In addition, while the fuselage 101 is illustrated as a closed structure in FIG. 8, in some embodiments, the fuselage 101 may not necessarily form a closed structure, but rather has certain degree and/or number of openings. Accordingly, one or more of the foregoing components or units may be disposed partially inside or outside the fuselage 101.

The flight controller 103 is electrically coupled to the motion sensor assembly 10. Specifically, the control circuit board 102 is electrically connected to the motion sensor assembly 10, so that the data information of the motion sensor assembly 10 may be acquired. In the disclosed embodiments, the flight controller 103 is a core component of a UAV 100 for managing the operating mode of the UAV 100 control system, for solving the control law and generating a control signal, for managing each sensor and servo system in the UAV 100, for controlling other tasks and electronic components and controlling data exchange in the UAV 100, for receiving ground commands and collecting the attitude information of the UAV 100, and the like. In some embodiments, the flight controller 103 may also be integrated with the motion sensor assembly 10.

The motion sensor 222 is used to determine and feed back the attitude information of the UAV 100, and is electrically connected to the flight controller 103 to transmit the attitude information of the UAV 100 determined by the motion sensor 222 to the flight controller 103, to allow the flight controller 103 to determine subsequent operations. The process of determining the attitude information of the UAV 100 by the motion sensor 222 includes that: the accelerometer (i.e., an acceleration sensor) detects a proper acceleration of the UAV 100 with respect to the ground perpendicular; the gyro (i.e., the speed sensor) detects the angular information of the UAV 100; the analog-to-digital converter receives the analog variables output by each sensor of the motion sensor, and converts the analog variables into digital signals; the flight controller 103 determines and outputs at least one angle information of the pitch angle, the yaw angle, or the roll angel of the UAV 100 according to the digital signals, to determine the attitude information of the UAV 100; where the electrically erasable programmable read-only memory (E/EPROM) is used to store the linear curve graph of each sensor of the motion sensor and the part number and serial number of each sensor of the motion sensor, to allow an image processing unit to read the linear curve parameters in the E/EPROM right after power-on, thereby providing initial information for subsequent angle calculations.

In addition, the UAV 100 of the present disclosure further includes an arm assembly disposed at the fuselage 101. The arm assembly includes an arm(s) 104 and a rotor assembly connected to the free end of the arm(s) 104. The rotor assembly includes a motor 105 and a propeller 106. The motor 105 is fixed to the arm 104 for driving the propeller 106 to rotate, thereby converting, through the propeller 106, the rotational power of the motor 105 to the propulsion propelling the UAV 100 to fly in the air.

The present disclosure provides a motion sensor assembly with a better protection performance, and a UAV thereof. The combined elasticity of the protective casing and the shock absorption mechanism allows the UAVs to achieve a six-sided buffering, which absorbs a large amount of shock effectively. Meanwhile, by fixing and restricting the connection line, the interference of the moving motion sensor assembly on the attitude of the UAV may be minimized. This ensures the accuracy of the flight control system command, and solves the problem that the motion sensor in the motion sensor assembly is prone to jamming or even damage when the UAV drops and move abruptly.

It should be noted that, in the present disclosure, relational terms such as “first” and “second” are merely used to distinguish one entity or operation from another entity or operation, but do not necessarily require or imply any such actual relationship or order between these entities or operations. The terms “including”, “comprising” or any other similar term are intended to be a non-exclusive inclusion, such that a process, method, article, or device, that comprises a serial of elements, includes not only those elements but also other elements not specifically listed, or elements that are inherent to such a process, method, item, or device. Without additional specification, an element that is defined by the phrase “comprising a . . . ” does not exclude the presence of additional equivalent elements in a process, method, item, or device that includes that element.

The methods and devices provided by the embodiments of the present disclosure are described in detail above. The principles and implementations of the present disclosure are described in the specific examples. The description of the above embodiments is only for helping understand the methods and the key concepts of the present disclosure. Clearly, for those skilled in the art, there will be changes in the specific embodiments and application scopes according to the concepts described in the present disclosure. In summary, the contents of this specification should not be construed as limitations of the present disclosure.

What is claimed is:

1. A motion sensor assembly, comprising: a mounting bracket, a sensor assembly body, and a shock absorption mechanism disposed between the mounting bracket and the sensor assembly body, the sensor assembly body including a protective casing, and a sensor module disposed in the protective casing, and the shock absorption mechanism including a plurality of elastic members;
wherein the plurality of the elastic members are disposed between the mounting bracket and the protective casing for shock absorption of the sensor module.

2. The motion sensor assembly of claim 1, wherein the plurality of the elastic members are respectively disposed at an edge of the protective casing or at a diagonal of the protective casing.

3. The motion sensor assembly of claim 2, wherein the plurality of elastic members have a same shock absorption coefficient.

4. The motion sensor assembly of claim 2, wherein a shock absorption coefficient of an elastic member adjacent to a center of gravity of the motion sensor assembly is greater than a shock absorption coefficient of an elastic member away from the center of gravity of the motion sensor assembly.

5. The motion sensor assembly of claim 1, wherein the plurality of the elastic members includes at least one of a shock absorption ball, a spring, a spring board, or a shock absorbing cushion.

6. The motion sensor assembly of claim 1, wherein:
an elastic member is a shock absorption ball; and
the shock absorption ball includes an upper end portion, a shock absorption main body, and an upper neck portion connected between the upper end portion and the shock absorption main body, wherein the upper end portion and the upper neck portion are used for connection to the protective casing, and the shock absorption main body abuts against the protective casing to absorb shock for the protective casing.

7. The motion sensor assembly of claim 6, wherein the protective casing is provided with a first mounting hole that holds the upper neck portion, and the upper neck portion has an axial height smaller than a depth of the first mounting hole, so that the shock absorption main body abuts against the protective casing, to allow the upper end portion and the shock absorption main body to be cooperatively snap-fitted in the protective casing.

8. The motion sensor assembly of claim 6, wherein the shock absorption ball further includes a lower end portion and a lower neck portion disposed between the lower end portion and the shock absorption main body, the lower neck portion and the lower end portion are for connection with the mounting bracket, and the shock absorbing main body abuts against the mounting bracket.

9. The motion sensor assembly of claim 8, wherein the mounting bracket is provided with a second mounting hole that holds the lower neck portion, and the lower neck portion has an axial height that is less than a depth of the second mounting hole, so that the shock absorption main body abuts against the mounting bracket, to allow the lower end portion and the shock absorption main body to be cooperatively snap-fitted on the mounting bracket.

10. The motion sensor assembly of claim 1, wherein the protective casing includes an upper casing and a lower casing, the shock absorption mechanism is connected to the upper casing, and the sensor module is disposed between the upper casing and the lower casing.

11. The motion sensor assembly of claim 10, wherein the protective casing further includes a receiving chamber disposed in the upper casing for holding the sensor module.

12. The motion sensor assembly of claim 10, wherein the protective casing further includes two latching arms oppositely disposed at the lower casing, and the two latching arms cooperatively clamped to the upper casing, to allow the upper casing to be snap-fitted on the lower casing.

13. The motion sensor assembly of claim 10, wherein the protective housing further includes a locking member disposed at the lower housing, and the locking member is located on a side of the lower housing opposite to the sensor module, to lead a connection line out of the lower casing from a bottom of the lower casing.

14. The motion sensor assembly of claim 10, wherein the sensor module further includes a control circuit board, a motion sensor disposed at the control circuit board, and a connection line electrically connected to a mounting carrier, the motion sensor being disposed at the control circuit board on a side opposite to the lower casing.

15. The motion sensor assembly of claim 1, wherein the mounting bracket is provided with a connecting portion for a mating connection with a mounting carrier.

16. An unmanned aerial vehicle, comprising a fuselage, a flight controller disposed at the fuselage, and a motion sensor assembly connected to the fuselage, wherein the flight controller is electrically connected to the motion sensor assembly, the motion sensor assembly includes a mounting bracket, a sensor assembly body, and a shock absorption mechanism connecting and disposed between the mounting bracket and the sensor assembly body, and the sensor assembly body includes a protective housing and a sensor module disposed at the protective housing, wherein:
the shock absorbing mechanism includes a plurality of elastic members; and
the plurality of the elastic members are disposed between the mounting bracket and the protective housing, and are used for shock absorption for the sensor module.

17. The unmanned aerial vehicle of claim 16, wherein the flight controller is integrated with the motion sensor assembly.

18. The unmanned aerial vehicle of claim 16, wherein the plurality of the elastic members are respectively disposed at an edge of the protective casing or at a diagonal of the protective casing.

19. The unmanned aerial vehicle of claim 16, wherein:
an elastic member is a shock absorption ball; and
the shock absorption ball includes an upper end portion, a shock absorption main body, and an upper neck portion connected between the upper end portion and the shock absorption main body, wherein the upper end portion and the upper neck portion are used for connection to the protective casing, and the shock absorption main body abuts against the protective casing to absorb shock for the protective casing.

20. The unmanned aerial vehicle of claim 16, wherein the mounting bracket is provided with a connecting portion for a mating connection with a mounting carrier.
